(19) United States
(12) Patent Application Publication
(10) Pub. No.: US 2023/0302763 A1
(43) Pub. Date: Sep. 28, 2023

(54) FILM

(71) Applicant: FUJIFILM CORPORATION, Tokyo (JP)

(72) Inventors: Kyohisa UCHIUMI, Kanagawa (JP); Ren ISHIKAWA, Kanagawa (JP)

(21) Appl. No.: 18/327,061

(22) Filed: Jun. 1, 2023

Related U.S. Application Data
(63) Continuation of application No. PCT/JP2021/036617, filed on Oct. 4, 2021.

(30) Foreign Application Priority Data
Dec. 16, 2020 (JP) 2020-208690

(51) Int. Cl. B32B 5/02; B32B 7/12

(52) U.S. Cl. CPC B32B 5/022; B32B 7/12; B32B 2250/03; B32B 2307/7265; B32B 2581/00; B32B 2264/025

(57) ABSTRACT

There is provided a film containing, in the following order, a base material, a permeation layer, and a water-absorbent polymer-containing layer, in which the water-absorbent polymer-containing layer is an outermost layer.

### CROSS-REFERENCE TO RELATED APPLICATIONS

This application is a Continuation of International Application No. PCT/JP2021/036617, filed Oct. 4, 2021, which claims priority to Japanese Patent Application No. 2020-208690, filed Dec. 16, 2020. Each of the above applications is hereby expressly incorporated by reference, in its entirety, into the present application.

### BACKGROUND OF THE INVENTION

### 1. Field of the Invention

The present disclosure relates to a film.

### 2. Description of the Related Art

In the related art, a waterproof sheet has been known as a sheet for preventing the infiltration of rainwater or the like into a house.

For example, JP2002-316373A describes a building waterproof sheet in which a first fabric having an anti-slip layer on an upper surface is adhered to an upper surface of a moisture permeable waterproof film, and a second fabric having a swelling layer is adhered to a lower surface of the moisture permeable waterproof film, where the swelling layer is interposed between the moisture permeable waterproof film and the second fabric. JP2009-084840A describes a waterproof sheet for a building base, which is a multilayer structure in which a nonwoven fabric having a swelling layer consisting of a water-absorbent polymer resin is sandwiched between two layers of a synthetic film. JP2016-094735A describes a waterproof sheet for a building base, which has a laminated structure of at least five layers in which an anti-slip layer, a first film layer, a water-absorbent swelling layer, a reinforced layer, and a second film layer are laminated in this order from the upper side in the vertical direction. JP2009-243093A describes a heat-shielding waterproof sheet for a building material, in which a base material nonwoven fabric layer, a polyolefin film layer, an intermediate nonwoven fabric layer, a swelling layer, an aluminum foil reinforced nonwoven fabric layer, and a surface layer aluminum foil are laminated in this order. JP2009-275415A describes a waterproof sheet for a building material, in which a base material nonwoven fabric layer, a swelling layer, an inner porous polyolefin film layer, an outer porous polyolefin film layer, a surface layer aluminum foil, and a surface layer aluminum foil sheet are laminated in this order.

### SUMMARY OF THE INVENTION

In a case where rainwater or the like infiltrates through a gap around a window, a door, or the like, it is required to cut off the water in a shorter time.

The present disclosure has been made in consideration of such circumstances, and according to an embodiment of the present invention, there is provided a film capable of cutting off the water in a short time.

The present disclosure includes the following aspects.
<1> A film comprising, in the following order:
a base material;
a permeation layer; and
a water-absorbent polymer-containing layer,
in which the water-absorbent polymer-containing layer is an outermost layer.
<2> The film according to <1>, in which at least a part of the water-absorbent polymer-containing layer penetrates into the permeation layer.
<3> The film according to <1>, in which the permeation layer has a porous structure.
<4> The film according to any one of <1> to <2>, in which the permeation layer is a nonwoven fabric or paper.
<5> The film according to any one of <1> to <3>, in which the base material has a waterproof function.
<6> The film according to any one of <1> to <4>, in which the water-absorbent polymer-containing layer contains particles of a water-absorbent polymer.
<7> The film according to any one of <1> to <5>, in which the water-absorbent polymer-containing layer contains an adhesive component.
<8> The film according to any one of <1> to <6>, further comprising:
an adhesive layer between the base material and the permeation layer,
in which a part of an adhesive surface on a side opposite to a side of the base material is exposed in the pressure-sensitive adhesive layer.
<9> The film according to <7>, in which a surface of the water-absorbent polymer-containing layer and the adhesive surface are on the same plane.

According to the present disclosure, there is provided a film capable of cutting off the water in a short time.

### BRIEF DESCRIPTION OF THE DRAWINGS

FIG. 1 is a schematic plan view illustrating a configuration of a film according to an embodiment of the present disclosure.

FIG. 2 is a cross-sectional view taken along the line A-A of FIG. 1.

FIG. 3 is a schematic cross-sectional view illustrating a configuration of a film according to another embodiment.

### DESCRIPTION OF THE PREFERRED EMBODIMENTS

Hereinafter, a film according to the present disclosure will be described in detail.

In the present disclosure, a range of numerical values described using “to” means a range including the numerical values listed before and after “to” as the lower limit and the upper limit.

In the present disclosure, in a case where there are a plurality of substances corresponding to each component in the composition, the amount of each component in the composition means the total amount of the plurality of substances present in the composition unless otherwise particularly specified.

Regarding numerical ranges that are described stepwise in the present disclosure, an upper limit value or a lower limit value described in a numerical value may be replaced with an upper limit value or a lower limit value of another stepwise numerical range, and it may be replaced with the value shown in Examples.

In the present disclosure, the term “step” includes not only an independent step but also a step that cannot be clearly distinguished from other steps, as long as the intended purpose of the step is achieved.

In the present disclosure, a combination of preferred embodiments is a more preferred embodiment.

Each element in each of the drawings shown in the present disclosure is not necessarily shown in terms of the accurate scale, and some parts may be shown emphasized since it is the main purpose to clearly show the principle of the present disclosure. In addition, the constitutional elements indicated by the same reference numerals in the drawings mean the same constitutional elements.

[Film]

The film according to the present disclosure includes, in the following order, a base material, a permeation layer, and a water-absorbent polymer-containing layer, in which the water-absorbent polymer-containing layer is an outermost layer. In a case of using the film according to the present disclosure in a gap around, for example, a window or a door, water can be cut off in a short time in a case where the water has infiltrated into the gap.

In the film according to the present disclosure, the water-absorbent polymer-containing layer swells in a case where the water-absorbent polymer-containing layer comes into contact with water. Since the water-absorbent polymer-containing layer is on the outermost layer of the film, the gap is blocked by the swollen water-absorbent polymer-containing layer, and thus water can be cut off. In addition, since the permeation layer is provided in the film according to the present disclosure, water permeates the permeation layer as well. This makes it possible for the water-absorbent polymer-containing layer to come into contact with water not only from the surface of the film but also from the surface on the permeation layer side, whereby the expansion of the water-absorbent polymer-containing layer is promoted and the water can be cut off in a short time.

Hereinafter, an embodiment of the film according to the present disclosure will be described with reference to the drawings.

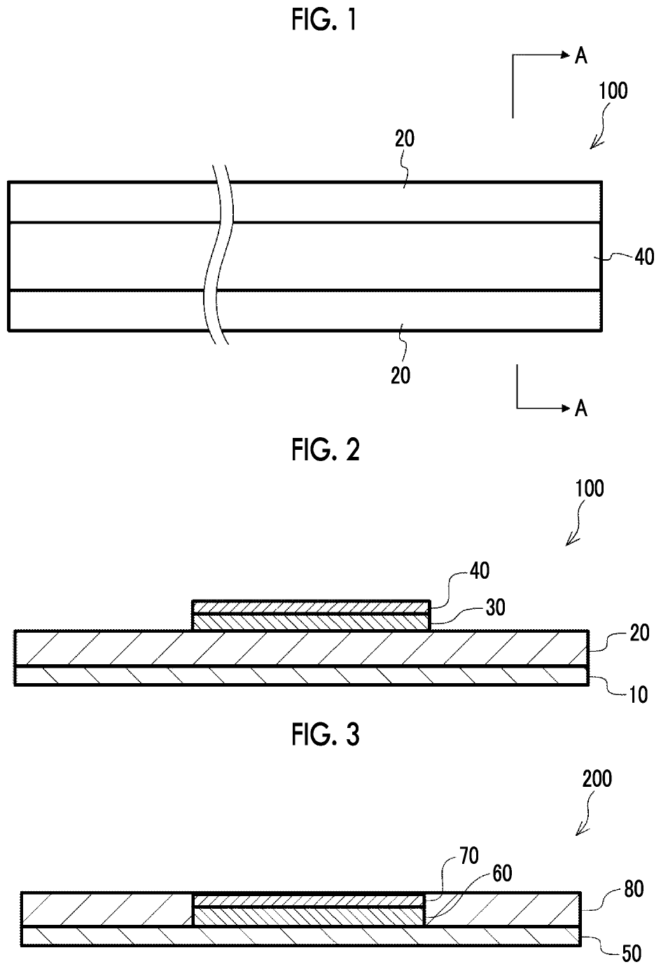

FIG. 1 is a schematic plan view illustrating a configuration of a film according to an embodiment of the present disclosure. FIG. 2 is a cross-sectional view taken along the line A-A of FIG. 1.

As illustrated in FIG. 2, a film 100 according to an embodiment of the present disclosure includes a base material 10, an adhesive layer 20, a permeation layer 30, and a water-absorbent polymer-containing layer 40 in this order.

(Base Material)

A material of the base material is not particularly limited, and it may be a resin or may be a metal. Among the above, the base material is preferably a resin base material. Examples of the resin base material include a base material containing polyolefin, polyester, polyethylene terephthalate (PET), polyethylene naphthalate (PEN), an acrylic resin, polycarbonate (PC), triacetyl cellulose (TAC), a cycloolefin polymer (COP), and a resin such as an acrylonitrile/butadiene/styrene copolymer resin (an ABS resin). Among them, the base material preferably contains polyethylene, polypropylene, or polyester from the viewpoint of waterproofness.

The base material preferably has a waterproof function. It is noted that in the present disclosure, “having a waterproof function” means a property that the amount of water leakage per hour is 500 g or less in a water filling test at a diameter of 10 mm.

The amount of water leakage is measured, for example, by the following method.

First, the base material is extracted from the film. Water is poured into a cylindrical tube having a diameter of 10 mm to a depth of 100 mm. A base material is attached to the opening of the cylindrical tube and the lid is closed. The cylindrical tube is held upside down for 1 hour. The amount (g) of water leaked in 1 hour is measured.

In a case where the base material has a waterproof function, the film is held in a predetermined place, and the durability against being flooded is improved.

The thickness of the base material is, for example, 15 μm to 200 μm.

The base material has an elongated shape, and the length and width of the base material are not particularly limited. The length means a length in the longitudinal direction of the base material, and the width means a length in the direction orthogonal to the longitudinal direction of the base material.

(Adhesive Layer)

The adhesive layer is a layer having an adhesive function. The adhesive layer preferably contains at least one adhesive component. Examples of the adhesive component include a silicone resin, an acrylic resin, a vinyl resin, polyurethane, polyamide, polyester, polyolefin, and rubber.

In the present disclosure, “adhesiveness” means that a material adheres to a member (for example, glass) and is capable of being separated therefrom, and it is distinguished from “adhesion”.

Examples of the silicone resin include an addition reaction type silicone resin, a peroxide curing type silicone resin, and a condensation type silicone resin.

Examples of the acrylic resin include a homopolymer of an acrylic acid ester compound and a copolymer of an acrylic acid ester compound and other monomers.

Examples of the acrylic acid ester compound include methyl (meth)acrylate, ethyl (meth)acrylate, butyl (meth)acrylate, 2-ethylhexyl (meth)acrylate, hydroxyethyl methacrylate, hydroxypropyl methacrylate, dimethylaminoethyl methacrylate, and glycidyl methacrylate. Examples of the other monomers include vinyl acetate, (meth)acrylonitrile, (meth)acrylamide, styrene, methacrylic acid, acrylic acid, itaconic acid, methylol acrylamide, and maleic acid anhydride.

Examples of the vinyl resin include polyvinyl alcohol and polyvinylpyrrolidone.

Examples of the polyurethane include polyester polyurethane and polycarbonate polyurethane.

Examples of the polyamide include a polyamide (an amide 11) obtained by ring-opening polycondensation of undecane lactam and a polyamide (an amide 12) obtained by ring-opening polycondensation of lauryl lactam.

Examples of the polyester include a condensation polymer of a polyvalent carboxylic acid and a polyhydric alcohol, and specific examples thereof include polyethylene terephthalate and polybutylene terephthalate.

Examples of the polyolefin include a homopolymer of an olefin and a copolymer of an olefin and another monomer. The olefin is preferably an olefin having 2 to 6 carbon atoms, and examples thereof include ethylene, propylene, butene, methyl pentene, and hexene. Examples of the copolymer of the olefin and the other monomer include an ethylene-vinyl acetate copolymer resin (EVA), an ethylene-acrylic acid copolymer (EAA), an ethylene-ethyl acrylate copolymer (EEA), and an ethylene-methyl methacrylate copolymer (EMMA).

Examples of the rubber include a styrene/butadiene copolymer (SBR, SBS), a styrene/isoprene copolymer (SIS), an acrylonitrile-butadiene copolymer (NBR), a chloroprene polymer, and an isobutylene/isoprene copolymer (butyl rubber).

The adhesive layer can be formed, for example, by applying a composition for an adhesive layer containing an adhesive component onto a base material and drying the composition for an adhesive layer. In addition to the adhesive component, the composition for an adhesive layer may contain components such as a solvent, an ultraviolet absorbing agent, an antioxidant, a crosslinking agent, a surfactant, a filler, a coloring agent, a light stabilizer, a viscosity improver, and a polymerization initiator.

In addition, the adhesive layer may be an adhesive body obtained by separating from a peeling liner of a commercially available double-sided adhesive sheet or double-sided adhesive tape. An adhesive layer can be formed by attaching an adhesive body obtained by separating from a peeling liner of a commercially available double-sided adhesive sheet or double-sided adhesive tape onto a base material.

A laminate consisting of the base material and the adhesive layer provided on the base material may be a commercially available single-sided adhesive sheet or single-sided adhesive tape.

The thickness of the adhesive layer is, for example, 10 μm to 500 μm.

In the film 100 according to the embodiment of the present disclosure, the length and the width of the adhesive layer 20 are substantially the same as the length and the width of the base material 10, and the adhesive layer 20 completely covers the base material 10.

(Permeation Layer)

The permeation layer is a layer having a function of permeating water and preferably has a porous structure. In a case where water permeates the permeation layer, the permeated water moves to the water-absorbent polymer-containing layer, and the swelling of the water-absorbent polymer-containing layer is promoted.

The water absorption speed of the permeation layer is preferably 0.004 g/mm²/s or more, more preferably 0.008 g/mm²/s or more, and still more preferably 0.05 g/mm²/s or more. In a case where the water absorption speed of the permeation layer is 0.004 g/mm²/s or more, the effect of promoting the swelling of the water-absorbent polymer-containing layer 40 is high.

The water absorption speed of the permeation layer is measured, for example, by the following method.

First, the permeation layer is extracted from the film. A sample having a width of 10 mm is prepared from the extracted permeation layer. The mass of the sample before water absorption is measured. A portion having a width of 10 mm and a length of 1 mm, which is one end of the sample, is immersed in water for 10 seconds. The mass of the sample after water absorption is measured. The water absorption speed is calculated according to the following expression.

Water absorption speed (g/mm²/s)=(mass of sample after water absorption−mass of sample before water absorption)/(cross-sectional area immersed in water)/(time of immersion in water)

It is noted that the cross-sectional area immersed in water is 10 mm² since the width is 10 mm and the length is 1 mm.

From the viewpoint of water permeability, the permeation layer is preferably a layer containing fibers and more preferably a layer containing cellulose fibers, rayon fibers, polyolefin fibers, or polyester fibers.

From the viewpoint of water permeability, the permeation layer is preferably a nonwoven fabric or paper and more preferably a nonwoven fabric.

In the film 100 according to the embodiment of the present disclosure, the width of the permeation layer 30 is preferably narrower than the width of the adhesive layer 20 as illustrated in FIG. 2. That is, it is preferable that the permeation layer 30 is provided on a part of the adhesive layer 20 without completely covering the adhesive layer 20. The permeation layer 30 is preferably provided so that it is positioned at the center in the width direction of the adhesive layer 20.

The thickness of the permeation layer is, for example, 50 μm to 500 μm.

Since the film 100 according to the embodiment of the present disclosure can come into contact with water not only from the surface of the film but also from the surface on the permeation layer side, the water-absorbent polymer-containing layer can be swelled over a wide range. As a result, the infiltration entrance of water can be reliably blocked. For example, in a case where unevenness is formed on the installation surface of the film 100, water also infiltrates through a gap between the base material and the installation surface. In addition, water may also infiltrate from both end parts in a direction perpendicular to the main surface of the film 100. In this way, in a case where the water that infiltrates from various directions permeates the permeation layer, the water can be supplied to the water-absorbent polymer-containing layer, and the water-absorbent polymer-containing layer can be swollen.

(Water-Absorbent Polymer-Containing Layer)

The water-absorbent polymer-containing layer is a layer containing a water-absorbent polymer provided on the permeation layer. The water-absorbent polymer-containing layer swells in a case where it absorbs water, and the water is cut off in a case where the infiltration entrance is blocked by the swelled water-absorbent polymer-containing layer.

“Water absorbency” means that a water absorption rate measured in accordance with the method A described in JIS K 7209: 2000 (ISO 62: 1999) is 12% or more. The water absorption rate is a percentage of a change in mass with respect to the initial mass calculated according to the following expression. The water absorption rate is preferably 15% or more and more preferably 20% or more. From the viewpoint of durability, the upper limit of the water absorption rate is preferably 60% or less and more preferably 50% or less.

Comment:

The corresponding ISO is added.

The water-absorbent polymer contained in the water-absorbent polymer-containing layer is not particularly limited as long as it is a polymer having a function of swelling in a case of coming into contact with water, and a generally known water-absorbent polymer can be used.

Examples of the water-absorbent polymer include a (meth)acrylic polymer, a vinyl-based polymer, and polysaccharides. In addition, examples of the water-absorbent polymer also include hydrophilic polyester, hydrophilic polyurethane (a polyethylene glycol (400)/1,4-butanediol/saturated methylenediphenyldiisocyanate copolymer), gelatin, a starch/sodium acrylate graft copolymer, and an isobutylene/maleic acid anhydride copolymer.

The (meth)acrylic polymer means a polymer containing a constitutional unit derived from a monomer having a (meth)acryloyl group. The (meth)acrylic polymer may be either a homopolymer or a copolymer.

Examples of the monomer having a (meth)acryloyl group include (meth)acrylic acid, (meth)acrylamide, and a (meth)acrylic acid ester.

Examples of the (meth)acrylamide include acrylamide, methacrylamide, N-methylacrylamide, N,N′-dimethylacrylamide, N,N′-dimethylmethacrylamide, and N-methylolacrylamide.

The (meth)acrylic acid ester is preferably a (meth)acrylic acid alkyl ester, and it is more preferably a (meth)acrylic acid alkyl ester having 1 to 4 carbon atoms in the alkyl moiety. Examples of the (meth)acrylic acid alkyl ester include methyl (meth)acrylate, ethyl (meth)acrylate, butyl (meth)acrylate, and isobutyl (meth)acrylate.

Examples of the (meth)acrylic polymer include polyacrylic acid, polymethacrylic acid, a polyacrylic acid salt, a crosslinked substance of polyacrylic acid, a crosslinked substance of a polyacrylic acid salt, an acrylic acid/acrylic acid salt copolymer, polyacrylamide, polymethacrylamide, an acrylamide-acrylic acid copolymer, an acrylamide/methacrylic acid copolymer, an acrylamide-methyl methacrylate copolymer, an acrylamide/methyl methacrylate copolymer, an N,N′-dimethylacrylamide/N-methylolacrylamide/methyl methacrylate copolymer, polymethyl (meth)acrylate, polyethyl (meth)acrylate, polybutyl (meth)acrylate, and polyisobutyl (meth)acrylate.

The weight-average molecular weight of the (meth)acrylic polymer is preferably 100,000 to 10,000,000, more preferably 250,000 to 5,000,000, and still more preferably 500,000 to 25,000,000.

The weight-average molecular weight means a value measured according to gel permeation chromatography (GPC). In the measurement according to gel permeation chromatography (GPC), HLC (registered trade name)-8020GPC (manufactured by Toso Corporation) is used as a measuring device, three columns of TSKgel (registered trade name) Super Multipore HZ-H (4.6 mm ID×15 cm, manufactured by Tosoh Corporation) are used as columns, and tetrahydrofuran (THF), N-methylpyrrolidone (NMP), dimethylformamide (DMF), or water is used as an eluent. In addition, the measurement is carried out using an RI detector at a sample concentration of 0.45% by mass, a flow rate of 0.35 ml/min, a sample injection amount of 10 μl, and a measurement temperature of 40° C. The calibration curve can be created using eight samples of “Standard sample TSK standard, polystyrene”: “F-40”, “F-20”, “F-4”, “F-1”, “A-5000”, “A-2500”, “A-1000”, and “n-propyl benzene”, manufactured by Tosoh Corporation.

The vinyl-based polymer means a polymer containing a constitutional unit derived from a monomer having a vinyl group. The vinyl-based polymer may be either a homopolymer or a copolymer.

Examples of the monomer having a vinyl group include vinyl acetate, vinylpyrrolidone, and vinyl methyl ether.

Examples of the vinyl-based polymer include polyvinyl alcohol, polyvinylpyrrolidone, polyvinylpolypyrrolidone, and polyvinyl methyl ether.

Examples of the polysaccharides include an alginic acid salt, xanthan gum, gellan gum, tragacanth gum, karaya gum, Arabic gum, carrageenan, dextrin, agar, pectin, pullulan, locust bean gum, sacran, tamarind seed gum, hydroxyethyl cellulose, hydroxypropyl cellulose, carboxymethyl cellulose, carboxymethylethyl cellulose, a hydroxypropyl cellulose salt, a carboxymethyl cellulose salt, a carboxymethyl ethyl cellulose salt, a cellulose nanofiber (a Tempo-oxidated cellulose nanofiber, a carboxymethylated cellulose nanofiber, a phosphoric acid esterified cellulose nanofiber, or a cellulose nanofiber by mechanical defibration), a chitosan nanofiber, a cellulose microfibril, a hyaluronic acid salt, and hyaluronic acid.

Among them, the water-absorbent polymer contained in the water-absorbent polymer-containing layer is preferably an acrylic acid/acrylic acid salt copolymer, and more preferably an acrylic acid/sodium acrylate copolymer.

In addition, the water-absorbent polymer contained in the water-absorbent polymer-containing layer is preferably crosslinked. A composition for a water-absorbent polymer-containing layer, which will be described later, may be prepared using a water-absorbent polymer crosslinked in advance and other components, or a composition for a water-absorbent polymer-containing layer may be prepared by mixing a non-crosslinked water-absorbent polymer, a crosslinking agent, and other components.

In addition, the water-absorbent polymer contained in the water-absorbent polymer-containing layer may have a form of particles from the viewpoint of enhancing the ability to cuff off the water. In a case where the water-absorbent polymer-containing layer contains particles of the water-absorbent polymer, it is preferable that the particles of the water-absorbent polymer are dispersed in the water-absorbent polymer-containing layer 40.

That is, it is preferable that the water-absorbent polymer-containing layer contains particles of the water-absorbent polymer. The water-absorbent polymer-containing layer may contain particles of the water-absorbent polymer and a non-particulate water-absorbent polymer. In addition, the water-absorbent polymer-containing layer may contain particles of the water-absorbent polymer and particles of a polymer other than the water-absorbent polymer.

The content of the water-absorbent polymer contained in the water-absorbent polymer-containing layer is, for example, 10% by mass to 100% by mass with respect to the total mass of the water-absorbent polymer-containing layer.

In addition, from the viewpoint of improving durability, the water-absorbent polymer-containing layer preferably contains an adhesive component. In a case where the water-absorbent polymer-containing layer contains an adhesive component, the water-absorbent polymer-containing layer has an adhesive function. In a case where the water-absorbent polymer-containing layer comes into contact with water and then swells, a force acts in a direction in which the film is separated. On the other hand, in a case where the water-absorbent polymer-containing layer has an adhesive function, the film is less likely to be separated, and the cutting-off of water can be maintained for a longer period of time.

Examples of the adhesive component include the same ones as the adhesive components contained in the adhesive layer. Among them, the adhesive component contained in the water-absorbent polymer-containing layer is preferably polyvinyl alcohol that also functions as the water-absorbent polymer.

The content of the adhesive component contained in the water-absorbent polymer-containing layer is, for example, 1% by mass to 20% by mass with respect to the total mass of the water-absorbent polymer-containing layer.

The water-absorbent polymer-containing layer can be formed, for example, by applying a composition for a water-absorbent polymer-containing layer containing a water-absorbent polymer onto a permeation layer and drying the composition for an adhesive layer.

In addition to the water-absorbent polymer, the composition for a water-absorbent polymer-containing layer may contain components such as a solvent, an ultraviolet absorbing agent, an antioxidant, a crosslinking agent, a surfactant, a filler, a coloring agent, a light stabilizer, a viscosity improver, and a polymerization initiator.

In the film 100 according to the embodiment of the present disclosure, the length and the width of the water-absorbent polymer-containing layer 40 are substantially the same as the length and the width of the permeation layer 30 as illustrated in FIG. 2. That is, the water-absorbent polymer-containing layer 40 completely covers the permeation layer 30. Therefore, as illustrated in FIG. 2, a part of the surface (the adhesive surface) on a side opposite to a side of the base material 10 is exposed in the adhesive layer 20. Since the adhesive surface of the adhesive layer 20 and the surface of the water-absorbent polymer-containing layer 40 are exposed on the same side with respect to the base material 10, the film 100 is installed so that the water-absorbent polymer-containing layer 40 is positioned in a gap or the like which is the infiltration entrance of water, and thus the adhesive surface is pressed against a member in the vicinity of the gap, whereby the film 100 is fixed.

As illustrated in FIG. 2, the film 100 according to the embodiment of the present disclosure has a convex shape in a cross-sectional view, in which the permeation layer 30 and the water-absorbent polymer-containing layer 40 protrude from the base material 10. Therefore, the gap can be blocked more quickly due to the swelling of the water-absorbent polymer-containing layer 40, and water can be cut off in a short time. In addition, since the water-absorbent polymer-containing layer 40 protrudes, it is easy to dispose the film 100 so that the water-absorbent polymer-containing layer 40 is positioned in the gap which is the infiltration entrance of water.

The thickness of the water-absorbent polymer-containing layer is, for example, 50 μm to 500 μm.

In FIG. 2, the interface between the water-absorbent polymer-containing layer 40 and the permeation layer 30 is clear. However, in reality, the interface is unclear since a part of the water-absorbent polymer-containing layer 40 penetrates into the permeation layer 30.

Here, the form in which a part of the water-absorbent polymer-containing layer penetrates into the permeation layer means a form in which the water-absorbent polymer-containing layer enters the permeation layer. In other words, a mixed region in which a part of the water-absorbent polymer-containing layer is mixed is formed in the permeation layer. It is noted that the thickness of the permeation layer is a thickness including a mixed region. In addition, the thickness of the water-absorbent polymer-containing layer is a thickness that does not include the mixed region.

The degree of permeability of the water-absorbent polymer-containing layer into the permeation layer is indicated by the proportion of the thickness at which the water-absorbent polymer-containing layer has penetrated into the permeation layer with respect to the total thickness of the water-absorbent polymer-containing layer. The degree of permeability of the water-absorbent polymer-containing layer into the permeation layer is preferably 20% to 90%. In a case where the degree of permeability is 20% to 90%, the supply rate of water to the water-absorbent polymer-containing layer is improved, and the swelling of the water-absorbent polymer-containing layer is promoted. As a result, the time required to cut off water is shortened. In addition, the water-absorbent polymer contained in the water-absorbent polymer-containing layer is crosslinked or closely attached to a material (for example, a nonwoven fabric) constituting the permeation layer, and thus the gelated water-absorbent polymer is difficult to be eluted, and the durability is improved.

### Modification Example

In the film 100 according to the embodiment of the present disclosure, the adhesive layer 20 is provided on the base material 10. However, the permeation layer 30 may be provided directly on the base material 10 without the adhesive layer 20. In this case, the film can be fixed by attaching the film from the outside of the base material to a place where water is desired to be cut off by using an adhesive tape or the like.

In the film 100 according to the embodiment of the present disclosure, the length and the width of the water-absorbent polymer-containing layer 40 are substantially the same as the length and the width of the permeation layer 30. However, the width of the water-absorbent polymer-containing layer 40 may be smaller than the width of the permeation layer 30. In a case where the width of the water-absorbent polymer-containing layer 40 is smaller than the width of the permeation layer 30, the water-absorbent polymer-containing layer 40 more easily absorbs water from the surface on the permeation layer 30 side, and the expansion of the water-absorbent polymer-containing layer 40 is promoted, whereby the water can be cut off in a short time.

### Another Embodiment

FIG. 3 is a schematic cross-sectional view illustrating a configuration of a film according to another embodiment of the present disclosure.

The film 100 according to the embodiment of the present disclosure has a convex shape in a cross-sectional view, in which the permeation layer 30 and the water-absorbent polymer-containing layer 40 protrude from the base material 10. However, As illustrated in FIG. 3, the surface of the water-absorbent polymer-containing layer 70 and the surface (adhesive surface) of the adhesive layer 80 on a side opposite to a side of the base material 50 may be on the same plane.

As illustrated in FIG. 3, a film 200 according to another embodiment of the present disclosure includes a permeation layer 60 and a water-absorbent polymer-containing layer 70 in this order on a part of a base material 50, and it has an adhesive layer 80 on a surface of the base material 50, on which the permeation layer 60 is not provided.

Preferred aspects of the base material 50, the permeation layer 60, the water-absorbent polymer-containing layer 70, and the adhesive layer 80 are the same as the preferred aspects of the base material 10, the permeation layer 30, the water-absorbent polymer-containing layer 40, and the adhesive layer 20, and thus the descriptions thereof will be omitted.

The film 200 according to the other embodiment of the present disclosure can be formed by, for example, the following two methods.

In the first forming method, first, a first adhesive layer having the same width as the base material is formed on the base material so that it overlaps the base material. A permeation layer having a width narrower than that of the first adhesive layer is attached to the center of the first adhesive layer, and a water-absorbent polymer-containing layer is further formed on the permeation layer. A second adhesive layer is formed on the surface of the first adhesive layer, on which the permeation layer is not provided. The second adhesive layer can be formed by subjecting a composition for an adhesive layer for forming the second adhesive layer, to pattern coating. Examples of the pattern coating method include a screen printing method and stripe coating. The height of the second adhesive layer is adjusted so that the surface of the second adhesive layer and the surface of the water-absorbent polymer-containing layer are on the same plane.

In the second forming method, a laminate in which the first adhesive layer, the permeation layer, and the water-absorbent polymer-containing layer, which are narrower than the base material, are laminated in this order is prepared in advance. The laminate is attached to the center of the base material so that the first adhesive layer is in contact with the base material. The second adhesive layer is formed on the surface of the base material, on which the laminate is not provided. The second adhesive layer can be formed by subjecting a composition for an adhesive layer for forming the second adhesive layer, to pattern coating. Examples of the pattern coating method include a screen printing method and stripe coating. The height of the second adhesive layer is adjusted so that the surface of the second adhesive layer and the surface of the water-absorbent polymer-containing layer are on the same plane.

It is noted that the first adhesive layer and the second adhesive layer may be an adhesive body obtained by separating from a peeling liner of a commercially available double-sided adhesive sheet or double-sided adhesive tape.

In the film 200 of the other embodiment of the present disclosure, the surface of the water-absorbent polymer-containing layer 70 and the surface (adhesive surface) of the adhesive layer 80 on a side opposite to a side of the base material 50 are on the same plane, and thus the film 200 is easy to be wound and stored in a roll shape.

### EXAMPLES

Hereinafter, Examples according to the present disclosure will be described; however, the present disclosure is not limited to Examples below.

### Example 1

<Preparation of Composition 1 for Water-Absorbent Polymer-Containing Layer>

8 parts by mass of aluminum glycinate was added to 600 parts by mass of glycerin, and the resultant mixture was stirred. Next, 100 parts by mass of an acrylic acid/sodium acrylate copolymer (product name “Viscomate NP-700”, manufactured by Showa Denko K.K.) was added thereto, and the resultant mixture was stirred. Further, an aqueous solution of tartrate acid prepared in advance (240 parts by mass of purified water and 0.8 parts by mass of tartrate acid) was added thereto, and the resultant mixture was stirred.

<Production of Film>

A composition 1 for a water-absorbent polymer-containing layer was applied onto a nonwoven fabric A (product name: “Absorbent Cotton”, manufactured by Hakujuji Co., Ltd., water absorption rate: 1.0 g/mm²) using a slot die. Then, drying was carried out with hot air of 10 m/sec at 80° C. The nonwoven fabric A on which the water-absorbent polymer-containing layer was formed was cut into a band having a width of 50 mm. As a cutting device, a general slitter device equipped with upper and lower round blades was used.

Next, a cut material was attached to the center of an adhesive tape (product name “TRUSCO air-permeable adhesive tape”, manufactured by TRUSCO NAKAYAMA CORPORATION, width 100 mm) so that the adhesive surface was in contact with the nonwoven fabric A, whereby a film having the same laminated structure in FIG. 2 was produced. As the bonding device, a bonding device including two general rollers was used.

It is noted that the adhesive tape used in Example 1 includes a base material and an adhesive layer, the material of the base material is polyester, and the adhesive layer contains rubber as an adhesive component. The base material has an amount of water leakage of 800 g per hour in a water filling test at a diameter of 10 mm and does not have a waterproof function.

### Example 2

A film was produced according to the same method as in Example 1, except that an adhesive tape (product name “Fit Light Tape Strong Adhesive Type No. 736 Mango, width: 100 mm”, manufactured by Sekisui Chemical Company, Limited) was used instead of the adhesive tape used in Example 1. It is noted that the adhesive tape used in Example 2 includes a base material and an adhesive layer, the material of the base material is polyester, and the adhesive layer contains an acrylic resin as an adhesive component. The base material has an amount of water leakage of 0 g per hour in a water filling test at a diameter of 10 mm and has a waterproof function.

### Example 3

A film was produced according to the same method as in Example 2, except that a nonwoven fabric B (product name “Technowipe”, manufactured by NIPPON PAPER CRECIA Co., Ltd., water absorption rate: 0.1 g/mm²/s) was used instead of the nonwoven fabric A used in Example 2.

### Example 4

A film was produced according to the same method as in Example 2, except that a nonwoven fabric C (product name “8890CR”, manufactured by JAPAN VILENE COMPANY, LTD., water absorption rate: 0.05 g/mm²) was used instead of the nonwoven fabric A used in Example 2.

### Example 5

<Preparation of Composition 2 for Water-Absorbent Polymer-Containing Layer>

8 parts by mass of aluminum glycinate was added to 600 parts by mass of glycerin, and the resultant mixture was stirred. Next, 80 parts by mass of an acrylic acid/sodium acrylate copolymer (product name “Viscomate NP-700”, manufactured by Showa Denko K.K.) and 20 parts by mass of polyvinyl alcohol were added thereto, and the resultant mixture was stirred. Further, an aqueous solution of tartrate acid prepared in advance (240 parts by mass of purified water and 0.8 parts by mass of tartrate acid) was added thereto, and the resultant mixture was stirred.

<Production of Film>

A film was produced according to the same method as in Example 2, except that a composition 2 for a water-absorbent polymer-containing layer was used instead of the composition 1 for a water-absorbent polymer-containing layer used in Example 2.

### Example 6

A laminate having the same laminated structure as in FIG. 2 was produced by the same method as in Example 2. Further, a bonded body obtained by bonding a double-sided tape (product name “Strong Double-sided Tape”, manufactured by Nitoms, Inc.) and an adhesive tape (product name “Fit Light Tape Strong Adhesive Type No. 736 Mango, width: 100 mm”, manufactured by Sekisui Chemical Company, Limited) were bonded together was bonded to a portion of the laminate, in which the adhesive surface was exposed, so that the double-sided tape was in contact with the adhesive surface, thereby producing a film. The thickness of the bonded body was adjusted in advance so that it was the same as the total thickness of the permeation layer and the water-absorbent polymer-containing layer in the laminate. As a result, the surface of the water-absorbent polymer-containing layer and the adhesive surface were on the same plane in the obtained film.

### Comparative Example 1

A film was produced according to the same method as in Example 1, except that the composition 1 for a water-absorbent polymer-containing layer was applied onto the adhesive tape without using a nonwoven fabric.

The time required to cut off water and the durability time were measured using the produced film. The measuring method is as follows.

(Time Required to Cut Off Water)

A water bath in which a hole having a width of 50 mm and a height of 10 mm was formed in the lower part of the wall surface was used as an experimental water bath. The produced film was attached from the inside of the experimental water bath so that the water-absorbent polymer-containing layer was positioned in the hole. Water was poured into the experimental water bath to a height of 500 mm. The time taken until the water stopped flowing out of the hole was measured, with a moment when the water was completely added being set as a start time. The measurement results are shown in Table 1.

(Durability Time)

In the same manner as in the measuring method for the “time required to cut off water” described above, water was poured into the experimental water bath to a height of 500 mm. The time taken until the water flowed out of the hole again was measured, with a time when the water stopped flowing out of the hole being set as a start time. The measurement results are shown in Table 1.

In Table 1, regarding whether or not the base material has a waterproof function, a case where the base material has a waterproof function is described as “Waterproof”, and a case where the base material does not have a waterproof function is described as “Non-waterproof”. In addition, the kind of the permeation layer is described, and it is described as “-” regarding Comparative Example 1 in which the permeation layer is not provided. Regarding whether or not the water-absorbent polymer-containing layer contains an adhesive component, a case where the adhesive component is contained is described as “Present”, and a case where the adhesive component is not contained is described as “Absent”. Regarding the positional relationship between the water-absorbent polymer-containing layer and the adhesive layer, whether or not they are on the same plane is described.

TABLE 1

| | | | | Positional relationship | | |
|---|---|---|---|---|---|---|
| | | | Presence or absence of pressure- | between water-absorbent | | |
| | | | sensitive adhesive component in | polymer-containing layer and | Time required | Dura- |
| | | | water-absorbent polymer-containing | pressure-sensitive adhesive | to cut off | bility |
| | Base material | Permeation layer | layer | layer | water | time |
| Example 1 | Non-waterproof | Nonwoven fabric A | Absent | On the same plane | 5 min | 12 h |
| Example 2 | Waterproof | Nonwoven fabric A | Absent | On the same plane | 5 min | 24 h |
| Example 3 | Waterproof | Nonwoven fabric B | Absent | On the same plane | 10 min | 24 h |
| Example 4 | Waterproof | Nonwoven fabric C | Absent | On the same plane | 30 mm | 24 h |
| Example 5 | Waterproof | Nonwoven fabric A | Present | On the same plane | 5 min | 36 h |
| Example 6 | Waterproof | Nonwoven fabric A | Absent | On the same plane | 10 min | 24 h |
| Comparative | Non-waterproof | — | Absent | On the same planc | 1 h | 12 h |
| Example 1 | | | | | | |

As shown in Table 1, in Example 1 to Examples 6, since the base material, the permeation layer, and the water-absorbent polymer-containing layer are provided in this order, and the water-absorbent polymer-containing layer is the outermost layer, it is possible to cut off water in a short time.

On the other hand, in Comparative Example 1, since the permeation layer is not provided, the time required to cut off water is 1 hour, which is considerably long as compared with those in Example 1 to Example 6.

In Example 2, since the base material has a waterproof function, the durability time is long as compared with that in Example 1.

In Example 5, since the water-absorbent polymer-containing layer contains the adhesive component, the durability time is long as compared with that in Example 2.

It is noted that the disclosure of Japanese patent application 2020-208690 filed on Dec. 16, 2020, is incorporated in the present specification by reference in its entirety. In addition, all documents, patent applications, and technical standards described in the present specification are incorporated in the present specification by reference, to the same extent as in the case where each of the documents, patent applications, and technical standards is specifically and individually described.

What is claimed is:

1. A film comprising, in the following order:
a base material;
a permeation layer; and
a water-absorbent polymer-containing layer,
wherein the water-absorbent polymer-containing layer is an outermost layer.

2. The film according to claim 1,
wherein at least a part of the water-absorbent polymer-containing layer penetrates into the permeation layer.

3. The film according to claim 1,
wherein the permeation layer has a porous structure.

4. The film according to claim 1,
wherein the permeation layer is a nonwoven fabric or paper.

5. The film according to claim 1,
wherein the base material has a waterproof function.

6. The film according to claim 1,
wherein the water-absorbent polymer-containing layer comprises particles of the water-absorbent polymer.

7. The film according to claim 1,
wherein the water-absorbent polymer-containing layer comprises an adhesive component.

8. The film according to claim 1, further comprising:
an adhesive layer between the base material and the permeation layer,
wherein a part of an adhesive surface on a side opposite to a side of the base material is exposed in the pressure-sensitive adhesive layer.

9. The film according to claim 8,
wherein a surface of the water-absorbent polymer-containing layer and the adhesive surface are on the same plane.
